(19) United States
(12) Patent Application Publication
(10) Pub. No.: US 2025/0148446 A1
(43) Pub. Date: May 8, 2025

(54) SYSTEMS AND METHODS FOR DETECTING COMPROMISE OF CO-LOCATED INTERACTION CARDS

(71) Applicant: Capital One Services, LLC, McLean, VA (US)

(72) Inventors: Matthew Louis NOWAK, Midlothian, VA (US); Michael Anthony YOUNG, JR., Henrico, VA (US); Christopher MCDANIEL, Glen Allen, VA (US)

(73) Assignee: Capital One Services, LLC, McLean, VA (US)

(21) Appl. No.: 18/502,547

(22) Filed: Nov. 6, 2023

(51) Int. Cl. G06Q 20/20; G06Q 20/40

(52) U.S. Cl. CPC G06Q 20/204; G06Q 20/401

(57) ABSTRACT

Disclosed are systems and methods for detecting compromise of a plurality of co-located interaction cards; including: receiving interaction information indicating that an interaction has been processed, the interaction information indicating that one of the plurality of co-located interaction cards was used in the interaction, the one of the plurality of co-located interaction cards used in the interaction having limited authorized interaction modalities. Based on a determination that the interaction was processed via an unauthorized modality, it is determined that all of the plurality of co-located interaction cards are potentially compromised. In response to determining that all of the plurality of co-located interaction cards are potentially compromised, corrective actions may be taken including: sending an alert to a cardholder; sending an alert to an issuer of at least one of the plurality of co-located interaction cards; or locking each of the plurality of co-located interaction cards.

### TECHNICAL FIELD

Various embodiments of the present disclosure relate generally to interaction cards, and more particularly, to systems and methods for detecting compromise of co-located interaction cards.

### BACKGROUND

Users often keep a plurality of interaction cards, such as credit cards, gift cards, or the like, together in one location. The plurality of interaction cards may be physically co-located in one place, such as a plurality of physical interaction cards in a wallet or a purse, or the plurality of interaction cards may be virtually co-located in one place, such as a plurality of virtual cards stored on a smart phone or other device. In either event, if a bad actor comes into possession of the wallet, purse, phone, or any other object or device on which the interaction cards are co-located, all of the co-located interaction cards may be compromised.

Users may not become aware of the compromise of their co-located interaction cards, such that they may fail to take timely action to prevent the co-located interaction cards from misuse. Users may also fail to be precisely aware of what interaction cards were contained in, for example, a stolen wallet, purse, or phone, such that even if they are aware of the theft, they may fail to take action to prevent one or more of the co-located interaction cards from misuse.

The present disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer-implemented method for detecting compromise of a plurality of co-located interaction cards; the method including: receiving, by a processor, interaction information indicating that an interaction has been processed, the interaction information indicating that one of the plurality of co-located interaction cards was used in the interaction, the one of the plurality of co-located interaction cards used in the interaction having limited authorized interaction modalities; determining, by the processor, that the interaction was processed via a modality not authorized under the limited authorized interaction modalities; based on the determination that the interaction was processed via an unauthorized modality, determining, by the processor, that all of the plurality of co-located interaction cards are potentially compromised; in response to determining that all of the plurality of co-located interaction cards are potentially compromised, performing, by the processor, at least one of: sending a first alert to a user device associated with the plurality of co-located interaction cards; sending a second alert to an issuer of at least one of the plurality of co-located interaction cards; or locking each of the plurality of co-located interaction cards from further use.

In some aspects, the techniques described herein relate to a computer-implemented method for detecting compromise of a plurality of co-located interaction cards, the method including: receiving, by a processor, interaction information indicating that an interaction has been processed, the interaction information including account data associated with a decoy interaction card; identifying, by the processor, a user associated with the decoy interaction card and one or more legitimate interaction cards co-located with the decoy interaction card; determining, by the processor, based on the account information including account data associated with a decoy interaction card, that the one or more legitimate interaction cards co-located with the decoy interaction card are potentially compromised; in response to determining that the one or more of legitimate interaction cards are potentially compromised, performing, by the processor, at least one of: sending a first alert to a user device associated with the user; sending a second alert to an issuer of at least one of the one or more legitimate interaction cards; voiding the interaction and sending a third alert to a merchant that processed the interaction; or locking each of the one or more legitimate interaction cards from further use.

In some aspects, the techniques described herein relate to a computer-implemented method for detecting compromise of a plurality of co-located interaction cards, the method including: receiving, by a processor, interaction information indicating that an interaction has been processed, the interaction information indicating that one of the plurality of co-located interaction cards was used in the interaction, the one of the plurality of co-located interaction cards used in the interaction being a decoy interaction card; the decoy interaction card including at least one of: a decoy magnetic strip; a decoy Europay, Mastercard, and Visa (EMV) chip; or decoy visible cardholder information; in response to receiving account information indicating that the decoy card was used in the interaction, performing, by the processor, at least one of: locking the co-located interaction cards from further use; transmitting a first alert a user device associated with the decoy interaction card; or transmitting a second alert to an issuer of at least one of the co-located interaction cards.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment for implementation of systems and methods for detecting compromise of co-located interaction cards, according to one or more embodiments.

FIG. 2 depicts an example of a plurality of physically co-located interaction cards, according to one or more embodiments.

FIG. 3 depicts an example of a plurality of virtually co-located interaction cards, according to one or more embodiments.

FIG. 4 depicts an example of an interaction card including one or more decoy or unauthorized modalities, according to one or more embodiments.

FIG. 5 depicts a flow chart for detecting and providing response to compromise of co-located interaction cards, according to one or more embodiments.

FIG. 6 depicts an example of a computing device, according to one or more embodiments.

### DETAILED DESCRIPTION OF EMBODIMENTS

According to certain aspects of the disclosure, systems and methods are disclosed for detecting compromise of co-located interaction cards, and more particularly, for detecting and providing response to potential and actual compromise of both physically and virtually co-located interaction cards.

Cardholders often keep some or all of their interaction cards, often their most used interaction cards, such as credit cards, debit cards, gift cards, loyalty cards, etc., in a single location, such as a purse or wallet. Cardholders may also keep their cards virtually or digitally in a single location, such as in the smart wallet of a smart phone, such as in a Google® wallet or in an Apple® wallet. When a plurality of interaction cards are co-located, such as in the situations described above, this creates a particular security threat when the item or device the interaction cards are co-located in is lost or stolen.

The techniques disclosed herein provide solutions for addressing the security concerns that may arise from losing possession of a plurality of co-located cards. The techniques include having a decoy card or decoy interaction modality that, when triggered, is detected as a possible compromise of the plurality of co-located cards, as described in more detail below. These techniques rely on the cardholder being aware of which interaction card is a decoy interaction card or which modalities are decoy modalities. For example, a cardholder may know that a yellow interaction card is the decoy interaction card, or that a card including a middle initial is the decoy interaction card, such that use of the decoy interaction card triggers an alert. A cardholder may also only authorize the cards for use when the card is used at a point-of-sale (POS) terminal, such that use online is unauthorized. In such a case, using such an interaction card may trigger an alert that all of the co-located cards may be compromised. This is especially useful where the cardholder may be unaware that the plurality of cards have been lost and/or stolen or where the cardholder may not remember all of the cards that were co-located in the lost or stolen item or device, as the alert may be sent to issuers of all of the co-located cards such that they may all be canceled or locked from further use.

The techniques disclosed herein provide technical benefits including automated and secure handling of compromised co-located interaction cards (e.g., credit cards, gift cards, etc.). Technical effects of the techniques disclosed herein include automatically and securely alerting cardholders, credit card companies, and merchants when one or more co-located interaction cards have been potentially or actually compromised. The cardholder or credit card companies, being the issuer of the card, may take corrective action such as cancelling the compromised interaction cards, or tracking their use to gain information about the culprit.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

Terms like “source,” “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser” or “extension” may be used interchangeably with other terms like “program,” “electronic application,” or the like, and generally encompasses software that is configured to interact with, modify, override, supplement, or operate in conjunction with other software.

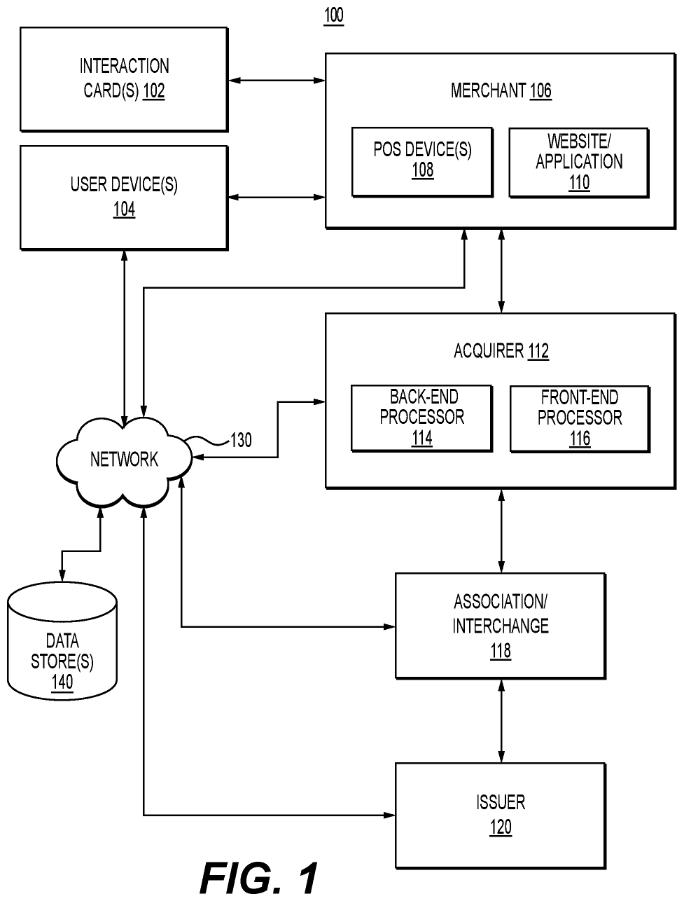

FIG. 1 depicts an example environment 100 for implementation of systems and methods for detecting compromise of co-located interaction cards, according to one or more embodiments. Environment 100 may include interaction card(s) 102, user device(s) 104, merchants 106 (e.g., merchants operating or associated with POS device(s) 108 and/or website/application 110), acquirers 112, association/interchange 118, and issuer 120, communicating over a communication infrastructure of network 130. Data store(s) 140 may be accessible throughout the environment 100, where data store(s) 140 may be cloud-based data store(s) accessible via network 130 or included with any of acquirer 112, association/interchange 118, issuer 120, or at the merchant 106 level or user level such as on a user device 104.

Interaction card(s) 102 may include any physical card product configured to store information, such as financial information (e.g., card numbers, account numbers, etc.), quasi-financial information (e.g., rewards balance, discount information, etc.), information pertaining to an interaction (e.g., interaction status, interaction amount, etc.) and/or individual-identifying information (e.g., name, address, etc.). Examples of interaction cards 102 include, but are not limited to, credit cards, gift cards, debit cards, loyalty cards, rewards cards, frequent flyer cards, merchant-specific cards, rewards cards, travel cards (e.g., a train pass, a bus pass, etc.), discount cards, insurance cards, etc. The interaction card(s) 102 may be physically co-located, for example in a wallet or purse. The interaction card(s) may also be virtually, or digitally, co-located on one or more user devices 104. User device(s) 104 may include mobile devices such as smart phones, smart watches, etc., that securely store card credentials and are capable of transmitting the card credentials to, for example, a POS terminal (e.g., POS device 108) and/or an input/output device.

The interaction card(s) 102 and/or the user device(s) 104 may be used to process an interaction at a merchant 106. A cardholder may possess a physical card or carry a device (e.g., a mobile device) that may interact with a merchant and/or a providing party (e.g., merchant 106) by presenting a physical interaction card (e.g., interaction card 102) or card credentials to a terminal (e.g., POS device 108). A cardholder may also enter the card credentials into a browser, web application, or mobile application (e.g., website/application 110) to process an interaction with merchant 106.

Processing an interaction may include, for example, paying for the purchase of a product from merchant 106 with an account associated with one or more of the interaction card(s) 102 physically, via a tap to pay application present on one of user device(s) 104 at a POS device 108 associated with the merchant 106, or in an online interaction via a merchant website or a merchant mobile application associated with merchant 106 (denoted by website/application 110 in FIG. 1). Processing an interaction may also include using card credentials to access entry to a secured location, e.g., badging in to enter a secured building or to enter a venue for a ticketed event.

Merchant 106 may be any merchant that accepts payment from a cardholder in exchange for goods or services, for example. Merchant 106 may be any retailer, service provider, business entity, or individual that accepts payments. Merchant 106 may include software, firmware and hardware for accepting and/or processing payments. For example, as illustrated in FIG. 1, merchant 106 may include a POS device 108 and/or an online store or application (e.g., website or application 110). Merchant also includes or is associated with a payment gateway (not shown). The payment gateway may be a web server to which POS device 108 and/or merchant's website/application 110 are connected, and which is further connected to acquirer 112 for relaying payment and interaction information from merchant to acquirer and information regarding approval or denial of the interaction from the acquirer to the merchant.

POS device 108 and payment gateway may comprise the physical or virtual device(s) used by merchant 106 to communicate information to front-end processor 116 of acquirer 112. POS device 108 may include an Europay, Mastercard, and Visa (EMV™) card reader to interact with an interaction card. In various embodiments, payment gateway may be an e-commerce application service provider service that authorizes payments for merchants. As such, payment gateway may be a virtual equivalent of a POS terminal and interface with, for example, a billing system of merchant 106 and pass data to front-end processor 116 of acquirer 112.

Acquirer 112 may be, for example, a financial institution or bank that holds the contract for providing payment processing services to merchant 106. Merchant 106 may have a merchant account that may serve as a contract under which acquirer 112 may extend a line of credit to a merchant who wishes to accept, for example, credit card interactions. As shown in FIG. 1, Acquirer 112 may be associated with front-end processor 116 and back-end processor 114.

In various examples, front-end processor 116 may be a platform that POS device 108, website/application 110, and/or a payment gateway communicate with when approving an interaction. Front-end processor 116 may include hardware, firmware, and software to process interactions. Front-end processor 116 may be responsible for the authorization and capture portion of credit card interaction. Front-end processor 116 also may include additional front-end platform interconnections to support, for example, automated clearing house (ACH) and debit interactions. Back-end processor 114 may be a platform that takes captured interactions from front-end processor 116 and settles them through an Interchange system (e.g., association/interchange 118). Association/interchange 118 may be the consumer payment system whose members are the financial institutions that issue payment cards and/or sign merchant to accept payment cards. Example associations/interchanges 118 may include, Visa®, MasterCard®, and American Express®. Association/interchange 118 may include one or more computer systems and networks to process interactions.

Issuer 120 may be a financial institution that issues payment cards and maintains a contract with cardholders for repayment. In various embodiments, issuer 120 may issue credit, debit, and/or stored value cards, for example. Example issuers may include, Capital One®, and the like.

In various embodiments, processing a payment card interaction may involve two stages: (1) authorization and (2) clearing and settlement. Authorization may refer to an electronic request that is sent through various parties to either approve or decline the interaction. During authorization, a cardholder may present an interaction card 102 as payment at merchant 106, for example at POS device 108.

Merchant 106 may enter the interaction card 102 into a physical POS device 108 (e.g., an EMV™ terminal) or submit a credit card interaction to a payment gateway on behalf of withdrawing party via secure connection from a website, retail location, or a wireless device. The payment gateway may receive the secure interaction information and may pass the secure interaction information via a secure connection to the merchant acquirer's 112 front-end processor 116.

Front-end processor 116 may submit the interaction to association/interchange 118 (e.g., a network of financial entities that communicate to manage the processing, clearing and settlement of credit card interactions). Association/interchange 118 may route the interaction to the cardholder's issuer 120. Issuer 120 may approve or decline the interaction and passes the interaction results back through association/interchange 118. Association/interchange then may relay the interaction results to front-end processor 116.

Front-end processor 116 may relay the interaction results back to the payment gateway and/or POS device 108. The merchant's payment gateway may store the interaction results and sends them to merchant 106. Merchant 106 may receive the authorization response and complete or deny the interaction, accordingly.

The plurality of co-located interaction cards 102 may include at least one decoy interaction modality that is intentionally not authorized by the cardholder. As described in more detail below, an interaction modality may be any of, for example, tapping to pay or authorize an interaction (such as tapping to pay via an antenna on a credit card or tapping to badge in to enter a building, e.g. via radio frequency identification (RFID), swiping to pay or authorize an interaction, inserting a chip into a POS device, and/or entering card credentials into a website or other electronic application via an input/output device to process an interaction. There may be a decoy card among the plurality of interaction cards 102 that has zero authorized modalities such that any attempt to use the card is unauthorized, or there may be one or more cards among the plurality of co-located interaction cards with limited authorized modalities (e.g., a card that has at least one decoy interaction modality). For example, at least one of the co-located interaction cards 102 may be unauthorized for online use but authorized for physical use such that online use is a decoy interaction modality.

When the decoy card or one of the co-located interaction cards 102 having a decoy (e.g., unauthorized) modality is used in an interaction, the interaction information for that interaction is transmitted to issuer 120. Issuer 120 may determine that the interaction modality was unauthorized and block that interaction from processing or take other corrective actions, as described in more detail below.

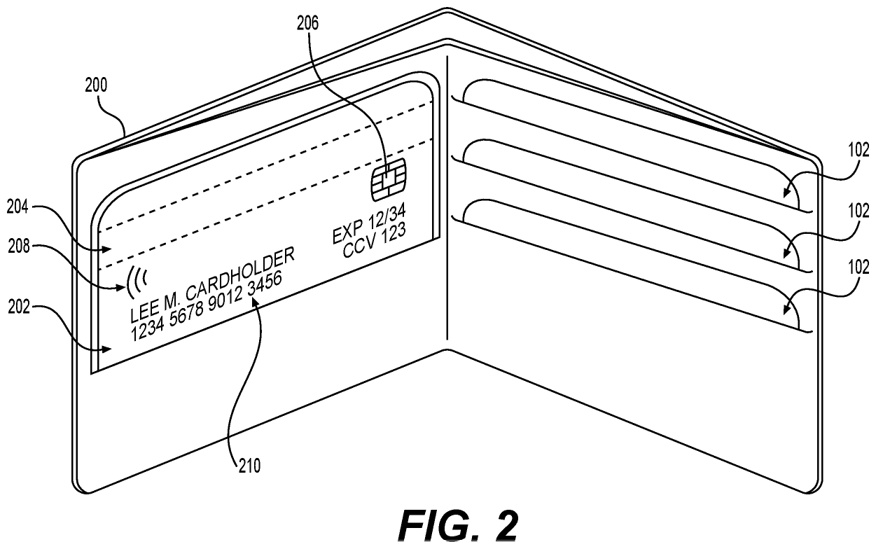

FIG. 2 depicts an example of a plurality of physically co-located interaction cards, according to one or more embodiments. A cardholder may store a plurality of co-located interaction cards 102 in a single carrying item (e.g., wallet 200). A cardholder may be an individual with which an account may be associated, with at least one of the co-located interaction cards connected to the account. Alternatively or additionally, a cardholder may be a legitimate user of the co-located interaction cards 102 and/or user devices 104. In some embodiments, among the plurality of co-located interaction cards 102 are interaction cards with legitimate interaction modalities and at least one interaction card with at least one decoy interaction modality. Legitimate interaction modalities are those authorized by the cardholder and the issuer, and decoy interaction modalities are those that are intentionally not authorized by the cardholder and the issuer.

A legitimate interaction card is a card with at least one legitimate interaction modality, e.g., the account information associated with that interaction card is associated with a real account and with which a legitimate interaction may be processed. A decoy interaction card is a card with no authorized interaction modalities and may not be associated with a legitimate account.

Among the plurality of co-located interaction cards 102 in wallet 200 may be a singular decoy interaction card 202 that has all modalities unauthorized and designed to trigger a possible compromise alert. For example, a decoy interaction card 202 may include a magnetic strip 204, a Eurocard™ Mastercard™ and Visa™ (EMV) chip 206, an antenna 208 used to enable tap to pay, and/or account data 210 including, for example, an interaction card number, an expiration date, and a card verification code (CVV). All of these elements lend themselves to different interaction modalities usable at merchant POS devices 108 or online on a merchant website/application 110 or mobile application. Yet none of them will allow for a legitimate interaction to be processed. In some embodiments, the interaction may be processed, but track further use of the decoy interaction card 202 or the other co-located interaction cards 102 after the first use of the decoy interaction card 202 to gain information about the culprit and/or their wherabouts.

In the example of the wallet 200, if a bad actor were to come into possession of the wallet 200 and all of the co-located interaction cards 102 therein, the legitimate interaction cards 102 become vulnerable to misuse. While a cardholder may become aware of the wallet 200 being lost or stolen and take corrective actions to cancel or otherwise lock all of the interaction cards 102 from use, there are situations in which the opportunity to take such corrective action is not available in a timely manner. For example, the cardholder may not be aware of the lost or stolen wallet 200, or the cardholder may not remember or be aware of all of the interaction cards 102 in the wallet 200, or the cardholder may not have an opportunity to take corrective action in time to prevent misuse of the interaction cards 102. However, if decoy interaction card 202 is used, it may trigger an alert (e.g., an automatic alert) to the cardholder and/or to the issuer 120 of all of the co-located interaction cards 102, and may lock the interaction cards 102 from further use. Information regarding the issuers 120 of all of the co-located interaction cards 102 may be stored in data store(s) 140, as shown in FIG. 1, such that alerts and requests for locking interaction cards 102 may be sent to all issuers 120, including those different from the issuer 120 of the decoy interaction card 202.

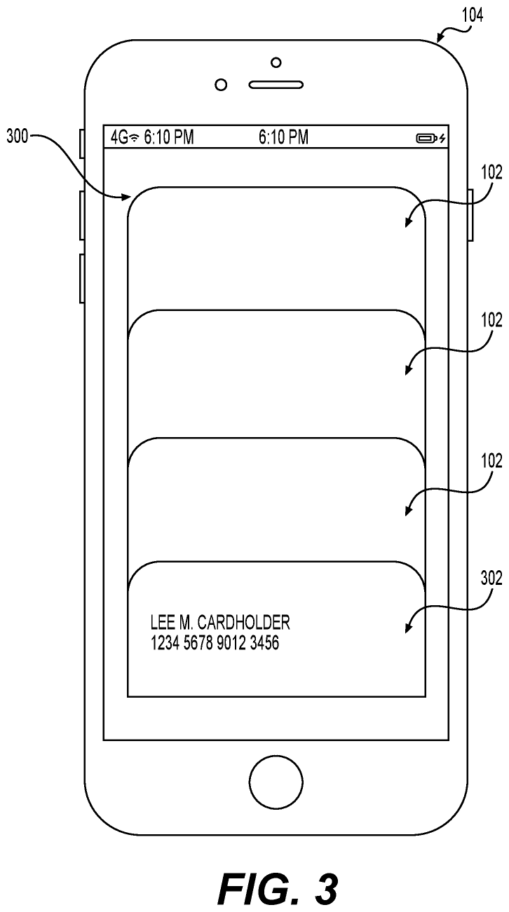

FIG. 3 depicts an example of a plurality of virtually co-located interaction cards, according to one or more embodiments, on a user device 104, for example a smartphone with a dedicated mobile wallet application 300. The mobile wallet application 300, such as Apple@ Pay or Google® Pay, securely stores card credentials and is capable of transmitting the card credentials to, for example, a POS terminal (e.g., POS device 108) and/or an input/output device. As mobile devices such as smartphones and smart watches and other similar devices are also susceptible to being lost or stolen, similar measures are beneficial in a digital or mobile wallet.

In the present example, the mobile wallet application 300 has stored card credentials for a plurality of interaction cards 102, including one decoy interaction card 302. Similarly to decoy interaction card 202 above, if decoy interaction card 302 is used, it may trigger an alert to the cardholder and/or to the issuer 120 of all of the co-located interaction cards 102, and may lock the interaction cards 102 from further use. Information regarding the issuers 120 of all of the co-located interaction cards 102 may be stored in data store(s) 140, as shown in FIG. 1, such that alerts and requests for locking cards may be sent to all issuers, including those different from the issuer of the decoy interaction card.

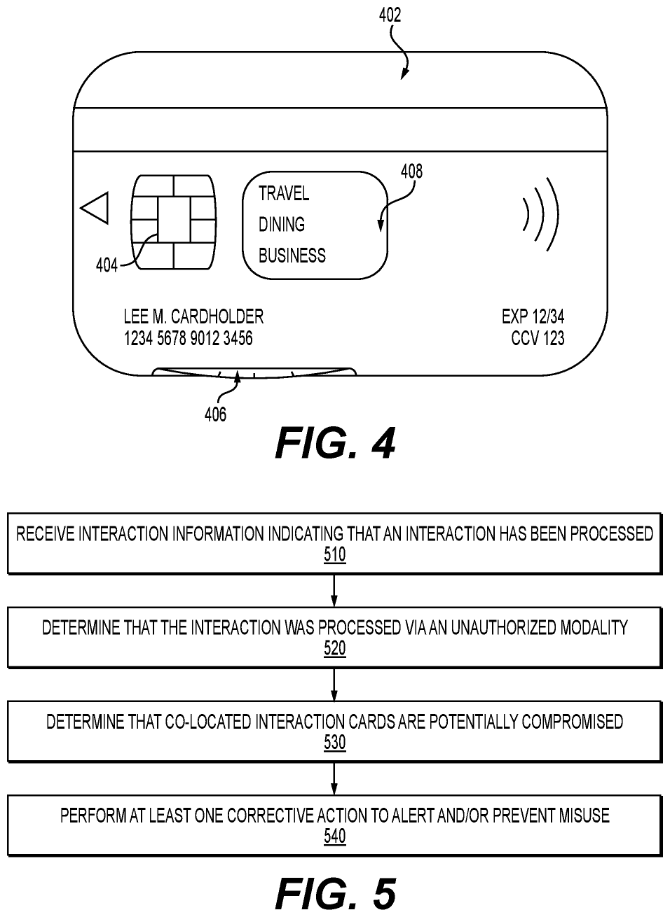

FIG. 4 depicts an example of an interaction card 402 including one or more decoy or unauthorized modalities, according to one or more embodiments. In the example of FIG. 4, interaction card 402 is a legitimate interaction card including a plurality of EMV chips 404. Each EMV chip 404 may be associated with a different account, and a dial 406 may be used to rotate an intended EMV chip into position for use. In the example of FIG. 4, two of three EMV chips 404 are associated with a respective legitimate credit card account, such as one for travel and one for dining, as indicated in indicator 408. Determining that the interaction was processed using either of the legitimate EMV chips would constitute a determination that the interaction was processed via an authorized modality. A third EMV chip may be associated with a decoy account, labeled business in the example of FIG. 4. The cardholder would be required to remember the EMV chip associated with the business account is the decoy EMV chip and avoid using it. However, if an interaction is processed via the decoy EMV chip, such as inserting the EMV chip into a POS device to pay for a purchase, it would be determined that the interaction was processed via an unauthorized modality.

FIG. 5 depicts a flow chart for detecting and providing response to compromise of co-located interaction cards, according to one or more embodiments. The steps in the flow chart may be computer-implemented. At step 510, interaction information is received indicating that an interaction has been processed. The interaction may have been processed at a POS terminal (e.g., POS device 108) via swipe, tap, or chip, the interaction may have been processed as an online payment, or the interaction may have been processed in any other manner. Tap to pay interactions are processed via activation of an onboard near-field communication device by bringing the interaction card in close proximity to the POS device 108.

The interaction information may include information about an interaction card used in the process. The interaction card may be a physical card such as a credit card, gift card, or the like, the card including a magnetic strip, an EMV chip, an antenna enabling tap to pay, or visible cardholder and account information that may be entered into a POS system to process interaction, or any combination thereof.

The interaction information may indicate that one a plurality of the co-located interaction cards was used in the interaction. As discussed above, “co-located” may apply to interaction cards formerly or currently physically co-located, e.g., in a cardholder's wallet or purse or otherwise, or it may apply to virtual co-location, such as among the cards accessible on a user's smartphone or other virtual wallet.

Some or all of the co-located interaction cards may have limited authorized interaction modalities. Interaction modalities include forms of using an interaction card to perform an interaction. For example, swiping an interaction card at a POS terminal constitutes one interaction modality, while inserting an EMV chip at a POS terminal constitutes another interaction modality. Tapping a smartphone to pay via a virtual wallet constitutes yet another interaction modality, as does entering a card number to perform an online interaction.

On at least one interaction card, one, some, or all of the modalities may be unauthorized as described above. In some embodiments, one of the plurality of co-located interaction cards may be a decoy card, meaning that all modalities on that card are unauthorized. In some embodiments, multiple interaction cards may be decoy cards, up to all but one of the interaction cards being a decoy card. In some embodiments, one of the plurality of co-located interaction cards may have one unauthorized modality. In some embodiments, one or more of the plurality of co-located interaction cards may have one or more unauthorized modalities. In some embodiments, all of the co-located interaction cards may have the same unauthorized modality.

Among all of the interaction modalities among all of the co-located interaction cards, at least one interaction modality may be a decoy interaction modality, i.e., an unauthorized interaction modality. As such, at least one and possibly more than one of the co-located interaction cards has limited authorized interaction modalities.

At step 520, it is determined whether the interaction was processed via an unauthorized modality under the limited authorized interaction modalities. For instance, if the interaction card identified in the received interaction information was a decoy card with zero authorized modalities, it would be determined that the interaction was processed via a modality not authorized under the limited authorization modalities. In other instances, it may be that the interaction card used was authorized, for example, using the magnetic strip and tap to pay at POS terminals, but not authorized for modalities involving online payments. In this instance, it is determined whether the interaction was processed via an authorized modality (e.g., magnetic strip, or tap to pay), or an unauthorized modality (e.g., payment made online, such as through a mobile application or web browser). If it is determined that the interaction was via an authorized modality, the interaction is authenticated as described in FIG. 1. If the interaction was processed using a decoy interaction modality, the determination is made that the interaction was processed via a modality not authorized under the limited authorized interaction modalities.

The plurality of interaction modalities may include: an online interaction; a POS interaction involving activation of an onboard near-field communication device, e.g., using tap to pay; a POS interaction involving swiping of a magnetic strip; a POS interaction involving insertion of an EMV chip; or a POS interaction involving communication with an electronic wallet via a user device. As described above, at least one of the plurality of co-located interaction cards used in the limited authorized interaction modalities is based on an authorizing of less than all of the plurality of interaction modalities, such that one or more of the plurality of interaction modalities is the unauthorized modality.

Based on the determination that the interaction was processed via an unauthorized modality, i.e., a modality not authorized under the limited interaction modalities, it is determined at step 530 that all of the co-located interaction cards are potentially compromised. Data store(s) 140 may include information regarding all of the co-located interaction cards, and the information may be provided by a cardholder. The data store(s) 140 thus may be accessed to determine (i) the cardholder with whom the interaction card used in the unauthorized modality is associated; (ii) the interaction cards co-located with the interaction card used and/or all interaction cards associated with the cardholder; and (iii) the issuers of the co-located interaction cards and/or the issuers of all interaction cards associated with cardholder.

At step 540, a series of corrective actions may be performed in response to the determination that the plurality of co-located interaction cards are potentially compromised. These actions may include at least one of sending a first alert to a user device associated with the plurality of co-located interaction cards, sending a second alert to an issuer of at least one of the plurality of co-located interaction cards notifying the issuer that each of the plurality of co-located interaction cards is potentially compromised, or locking each of the plurality of co-located interaction cards from further use. Information describing the interaction may also be captured to help determine whether the cards are in fact compromised, and if so, information regarding the potential culprit. In instances where the plurality of co-located interaction cards include cards issued by different issuers, each issuer of each interaction card may be separately notified using the same second alert.

The terms “first alert” and “second alert” are used not to denote that the second alert follows after the first alert in time, but to denote that the second alert is different from the first alert. The second alert may be sent before the first alert, concurrently with the first alert, and furthermore may be sent whether the first alert is sent or not. The alert to the cardholder or user associated with the plurality of co-located interaction cards may include a push notification, SMS text, e-mail, phone call, or any other communication modality, that each of the plurality of co-located interaction cards may be potentially compromised. The alert may include causing a user device associated with the cardholder or user to output an option to authenticate the interaction, in case the interaction using an unauthorized modality was an honest mistake by the cardholder. In this respect, the alert may include a notice giving the user an option to authenticate the interaction. If the unauthorized modality was a use by user device 104, the first alert may be sent via a communication modality other than push notification or SMS text so as not to potentially alert a bad actor that the co-located interaction cards are compromised. E-mail may be used in such an instance.

It may also be determined whether the interaction using an unauthorized modality is a first interaction using the unauthorized modality or a subsequent interaction using the unauthorized modality. If it is a first interaction, the interaction may be allowed to be completed. If it is a second or subsequent interaction, the interaction may be voided. This allows for potentially tracking a culprit that stole or took possession of a lost wallet or user device while notifying the cardholder and/or issuer that the interaction cards may be compromised. Alternatively, it may provide an opportunity for a legitimate cardholder that accidentally used a decoy interaction card or decoy interaction modality to take corrective action before the co-located cards are locked from further use.

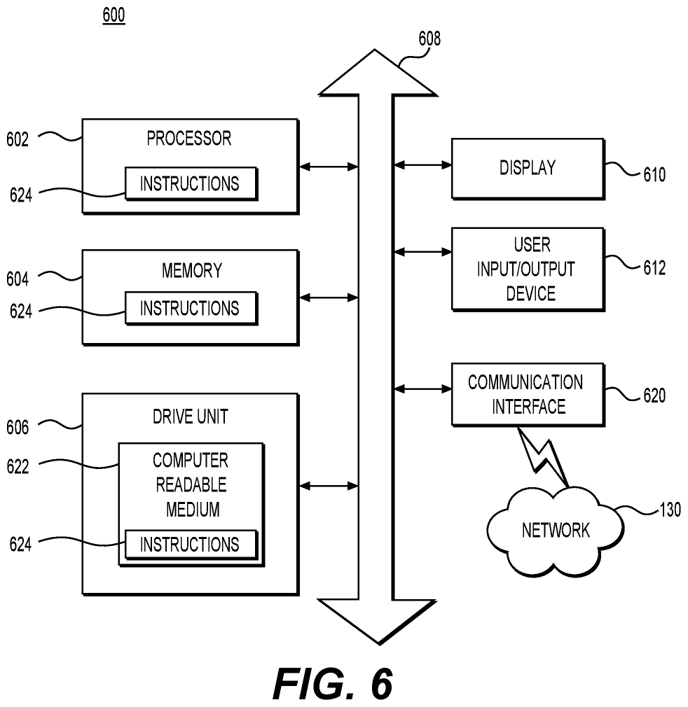

FIG. 6 illustrates an implementation of a computer system that executes techniques presented herein. The computer system may execute the computer-implemented flow chart described in FIG. 5. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 600 operates in the capacity of a server or as a client user computer in a server-client user network environment, or as a peer computer system in a peer-to-peer (or distributed) network environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, e.g., a central processing unit (CPU), a graphics processing unit (GPU), or both. The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (i.e., programmed).

The computer system 600 includes a memory 604 that communicates via bus 608. The memory 604 is a main memory, a static memory, or a dynamic memory. The memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 is an external storage device or data store(s) for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by the processor 602 executing the instructions stored in the memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. The sets of instructions 624 resides completely or partially within the memory 604 and/or within the processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to network 130 communicates voice, video, audio, images, or any other data over the network 130. Further, the sets of instructions 624 are transmitted or received over the network 130 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 130, external media, the display 610, or any other components in the computer system 600, or combinations thereof. The connection with the network 130 is a physical connection, such as a wired Ethernet connection, or is established wirelessly as discussed below. Likewise, the additional connections with other components of the computer system 600 are physical connections or are established wirelessly. The network 130 alternatively be directly connected to the bus 608.

While the computer-readable medium 622 is shown to be a single medium, the term “computer-readable medium” includes a single medium or multiple media, such as a centralized or distributed data store(s), and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to the network 130. The network 130 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 130 includes wide area networks (WAN), such as the Internet, local area networks (LAN), campus area networks, metropolitan area networks, a direct connection such as through a Universal Serial Bus (USB) port, or any other networks that allows for data communication. The network 130 is configured to couple one computing device to another computing device to enable communication of data between the devices. The network 130 is generally enabled to employ any form of machine-readable media for communicating information from one device to another. The network 130 includes communication methods by which information travels between computing devices. The network 130 is divided into sub-networks. The sub-networks allow access to all of the other components connected thereto or the sub-networks restrict access between the components. The network 130 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention are practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications are made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for detecting compromise of a plurality of co-located interaction cards; the method comprising:
receiving, by a processor, interaction information indicating that an interaction has been processed, the interaction information indicating that one of the plurality of co-located interaction cards was used in the interaction, the one of the plurality of co-located interaction cards used in the interaction having limited authorized interaction modalities;
determining, by the processor, that the interaction was processed via a modality not authorized under the limited authorized interaction modalities;
based on the determination that the interaction was processed via an unauthorized modality, determining, by the processor, that all of the plurality of co-located interaction cards are potentially compromised;
in response to determining that all of the plurality of co-located interaction cards are potentially compromised, performing, by the processor, at least one of:
sending a first alert to a user device associated with the plurality of co-located interaction cards;
sending a second alert to an issuer of at least one of the plurality of co-located interaction cards; or
locking each of the plurality of co-located interaction cards from further use.

2. The computer-implemented method of claim 1, wherein the one of the plurality of co-located interaction cards used in the interaction is usable via a plurality of interaction modalities, the plurality of interaction modalities including:
an online interaction;
a point-of-sale (POS) interaction involving activation of an onboard near-field communication device;
a POS interaction involving swiping of a magnetic strip;
a POS interaction involving insertion of an EMV chip; or
a POS interaction involving communication with an electronic wallet via a user device;
wherein the one of the plurality of co-located interaction cards used in the limited authorized interaction modalities is based on an authorizing of less than all of the plurality of interaction modalities, such that one or more of the plurality of interaction modalities is the unauthorized modality.

3. The computer-implemented method of claim 2, wherein:
upon determining that the interaction was performed using the unauthorized modality, the processor is configured to determine whether the interaction is a first interaction using the unauthorized modality or a subsequent interaction using the unauthorized modality; and
the processor is further configured such that the interaction is allowed to be completed upon determining that the interaction is the first interaction using the unauthorized modality, and the interaction is voided upon determining that the interaction is the subsequent interaction using the unauthorized modality.

4. The computer-implemented method of claim 1, wherein the plurality of interaction cards includes at least one decoy interaction card having zero authorized modalities, wherein the determining that the interaction was processed via an unauthorized modality comprises determining that the interaction was processed using the at least one decoy interaction card.

5. The computer-implemented method of claim 4, wherein upon determining that the interaction was processed using the at least one decoy interaction card, the processor is configured to capture information describing the interaction.

6. The computer-implemented method of claim 1, wherein the plurality of co-located interaction cards includes at least one decoy interaction card and at least one legitimate interaction card, wherein the determining that the interaction was processed via an unauthorized modality comprises determining that the interaction was processed using the at least one decoy interaction card; and
upon determining that the interaction was processed using the at least one decoy interaction card, the processor is configured to capture information describing the interaction.

7. The computer-implemented method of claim 1, wherein the plurality of co-located interaction cards includes at least one legitimate interaction card, the at least one legitimate interaction card including a plurality of Europay, Mastercard and Visa (EMV) chips, wherein
the plurality of EMV chips includes at least one decoy EMV chip, and
the determining that the interaction was processed via an unauthorized modality comprises determining that the interaction was processed using the at least one decoy EMV chip.

8. The computer-implemented method of claim 1, further comprising:
in response to determining that all of the plurality of co-located interaction cards are potentially compromised, performing, by the processor:
sending the first alert to the user device associated with the plurality of co-located interaction cards, wherein the sending of the first alert to the user associated with the plurality of co-located interaction cards includes notifying the user that each of the plurality of co-located interaction cards is potentially compromised.

9. The computer-implemented method of claim 8, wherein the sending of the first alert to the user associated with the plurality of co-located interaction cards further includes causing a user device associated with the user to output an option to authenticate the interaction.

10. The computer-implemented method of claim 1, further comprising:
in response to determining that all of the plurality of co-located interaction cards are potentially compromised, performing, by the processor:
sending the second alert to the issuer of at least one of the plurality of co-located interaction cards, wherein the sending of the second alert to the issuer of at least one of the plurality of co-located interaction cards includes notifying the issuer that each of the plurality of co-located interaction cards is potentially compromised.

11. A computer-implemented method for detecting compromise of a plurality of co-located interaction cards, the method comprising:
receiving, by a processor, interaction information indicating that an interaction has been processed, the interaction information including account data associated with a decoy interaction card;
identifying, by the processor, a user associated with the decoy interaction card and one or more legitimate interaction cards co-located with the decoy interaction card;
determining, by the processor, based on the account information including account data associated with a decoy interaction card, that the one or more legitimate interaction cards co-located with the decoy interaction card are potentially compromised;
in response to determining that the one or more of legitimate interaction cards are potentially compromised, performing, by the processor, at least one of:
sending a first alert to a user device associated with the user;
sending a second alert to an issuer of at least one of the one or more legitimate interaction cards;
voiding the interaction and sending a third alert to a merchant that processed the interaction; or
locking each of the one or more legitimate interaction cards from further use.

12. The computer-implemented method of claim 11, wherein upon determining that the interaction was processed using the at least one decoy interaction card, the processor is configured to capture information describing the interaction.

13. The computer-implemented method of claim 11, further comprising:
in response to determining that all of the plurality of co-located interaction cards are potentially compromised, performing, by the processor: sending the first alert to the user device associated with the plurality of co-located interaction cards, wherein the sending of the first alert to the user associated with the plurality of co-located interaction cards includes notifying the user that each of the plurality of co-located interaction cards is potentially compromised.

14. The computer-implemented method of claim 13, wherein the sending a first alert to the user associated with the one or more legitimate interaction cards further includes giving the user an option to authenticate the interaction.

15. The computer-implemented method of claim 11, further comprising:
in response to determining that all of the plurality of co-located interaction cards are potentially compromised, performing, by the processor: sending the second alert to the issuer of at least one of the plurality of co-located interaction cards, wherein the sending of the second alert to the issuer of at least one of the plurality of co-located interaction cards includes notifying the issuer that each of the plurality of co-located interaction cards is potentially compromised.

16. A computer-implemented method for detecting compromise of a plurality of co-located interaction cards, the method comprising:
receiving, by a processor, interaction information indicating that an interaction has been processed, the interaction information indicating that one of the plurality of co-located interaction cards was used in the interaction, the one of the plurality of co-located interaction cards used in the interaction being a decoy interaction card; the decoy interaction card comprising at least one of:
a decoy magnetic strip;
a decoy Europay, Mastercard, and Visa (EMV) chip; or
decoy visible cardholder information;
in response to receiving account information indicating that the decoy card was used in the interaction, performing, by the processor, at least one of:
locking the co-located interaction cards from further use;
transmitting a first alert a user device associated with the decoy interaction card; or
transmitting a second alert to an issuer of at least one of the co-located interaction cards.

17. The computer-implemented method of claim 16, wherein in response to receiving account information indicating that the decoy card was used in the interaction, the processor is configured to capture information describing the interaction.

18. The computer-implemented method of claim 16, wherein the first alert is transmitted to the user device associated with the decoy interaction card, and transmitting the first alert to the user device associated with the decoy interaction card includes causing the user device to output a notification indicating that each of the plurality of co-located interaction cards are potentially compromised.

19. The computer-implemented method of claim 18, wherein transmitting the first alert to the user device associated with the decoy interaction card further includes causing the user device to output an option to authenticate the interaction.

20. The computer-implemented method of claim 16, wherein the second alert is transmitted to the issuer of at least one of the co-located interaction cards, sending the second alert to the issuer of at least one of the co-located interaction cards includes notifying the issuer that each of the plurality of interaction cards are potentially compromised.
